(19) United States
(12) Patent Application Publication
(10) Pub. No.: US 2014/0221025 A1
(43) Pub. Date: Aug. 7, 2014

(54) GROUP PAGING AND SERVICE REQUEST

(71) Applicants: Devaki Chandramouli, Plano, TX (US); Xiao Tang Xie, Beijing (CN); Robert Zaus, Munich (DE)

(72) Inventors: Devaki Chandramouli, Plano, TX (US); Xiao Tang Xie, Beijing (CN); Robert Zaus, Munich (DE)

(73) Assignee: NOKIA SOLUTIONS AND NETWORKS OY, Espoo (FI)

(21) Appl. No.: 14/347,777

(22) PCT Filed: Sep. 30, 2011
(86) PCT No.: PCT/US2011/054117

§ 371 Date: Mar. 27, 2014

(51) Int. Cl. H04W 8/08

(52) U.S. Cl. CPC H04W 8/08
USPC 455/458

(57) ABSTRACT

The interaction between group paging and service requests can be enhanced through the appropriate use of a shared identifier and user equipment strategies for reacting when paged. These enhancements may be broadly applicable to many communication systems, such as evolved packet system (EPS) as well as general packet radio service (GPRS)/universal mobile telecommunications system (UMTS) networks. For example, a method according to certain embodiments can include preparing a response including a group shared unique identifier upon receiving an attach request or a tracking area update request. The method can also include sending the response to a user equipment in an attach accept or tracking area update accept message.

### BACKGROUND

1. Field

The interaction between group paging and service requests can be enhanced through the appropriate use of a shared identifier and user equipment strategies for reacting when paged. These enhancements may be broadly applicable to many communication systems, such as evolved packet system (EPS) as well as general packet radio service (GPRS)/universal mobile telecommunications system (UMTS) networks.

2. Description of the Related Art

So-called machine type communications (MTC) devices use similar applications and may have, for example, similar quality of service (QoS) needs. These devices often behave in a similar way to one another. For example, smart meters can send a small amount of data once a day to a server, accessing the network almost simultaneously with one another. Identifying ways to optimize usage of network resources for these devices may be beneficial. When the network needs to page the devices in a group, the network can minimize bandwidth on the paging channel by paging all the devices in a group with a single paging message.

If a group of user equipment (UE(s)) are paged at the same time, then conventionally the UE will immediately respond to the paging by sending a Service Request message. This can result in congestion.

### SUMMARY

According to certain embodiments, a method includes, upon receiving an attach request or a tracking area update request, preparing a response including a group shared unique identifier. The method also includes sending the response to a user equipment in an attach accept or tracking area update accept message.

A method, according to certain embodiments, includes, upon receiving a paging, waiting a time interval. The method also includes, after waiting the time interval, submitting a service request based on information in a previously received attach accept or tracking area update accept, wherein the information includes a group shared unique identifier.

A method includes, upon receiving a group paging, sending a service request to a master user equipment, in certain embodiments. The master user equipment is configured to send a group service request to a mobility management entity on behalf of user equipment associated with the master user equipment.

A method includes, in certain embodiments, upon receiving a group paging and at least one service request, sending a group service request to a mobility management entity. The group paging is received from a mobility management entity. The service request is received from a user equipment associated with a master equipment that performs the sending of the group service request.

In certain embodiments, an apparatus includes at least one processor and at least one memory including computer program instructions. The at least one memory and the computer program instructions are configured to, with the at least one processor, cause the apparatus at least to, upon receiving an attach request or a tracking area update request, prepare a response including a group shared unique identifier. The at least one memory and the computer program instructions are also configured to, with the at least one processor, cause the apparatus at least to send the response to a user equipment in an attach accept or tracking area update accept message.

An apparatus, according to certain embodiments, includes at least one processor and at least one memory including computer program instructions. The at least one memory and the computer program instructions are configured to, with the at least one processor, cause the apparatus at least to, upon receiving a paging, wait a time interval. The at least one memory and the computer program instructions are also configured to, with the at least one processor, cause the apparatus at least to, after waiting the time interval, submit a service request based on information in a previously received attach accept or tracking area update accept, wherein the information includes a group shared unique identifier.

An apparatus includes, according to certain embodiments, at least one processor and at least one memory including computer program instructions. The at least one memory and the computer program instructions are configured to, with the at least one processor, cause the apparatus at least to, upon receiving a group paging, send a service request to a master user equipment. The master user equipment is configured to send a group service request to a mobility management entity on behalf of user equipment associated with the master user equipment.

An apparatus includes at least one processor and at least one memory including computer program instructions, according to certain embodiments. The at least one memory and the computer program instructions are configured to, with the at least one processor, cause the apparatus at least to, upon receiving a group paging and at least one service request, send a group service request to a mobility management entity. The group paging is received from a mobility management entity. The service request is received from a user equipment associated with a master equipment that performs the sending of the group service request.

An apparatus, in certain embodiments, includes preparing means for, upon receiving an attach request or a tracking area update request, preparing a response including a group shared unique identifier. The apparatus also includes sending means for sending the response to a user equipment in an attach accept or tracking area update accept message.

In certain embodiments, an apparatus includes delay means for, upon receiving a paging, waiting a time interval. The apparatus also includes submitting means for, after waiting the time interval, submitting a service request based on information in a previously received attach accept or tracking area update accept, wherein the information includes a group shared unique identifier.

An apparatus includes receiving means for receiving a group paging, in certain embodiments. The apparatus also includes sending means for, upon receiving the group paging, sending a service request to a master user equipment. The master user equipment is configured to send a group service request to a mobility management entity on behalf of user equipment associated with the master user equipment.

An apparatus includes, in certain embodiments, receiving means for receiving a group paging. The apparatus also includes sending means for, upon receiving the group paging and at least one service request, sending a group service request to a mobility management entity. The group paging is received from a mobility management entity. The service request is received from a user equipment associated with a master equipment that performs the sending of the group service request.

A non-transitory computer readable medium is, in certain embodiments, encoded with instructions that, when executed in hardware, perform a process. The process includes, upon receiving an attach request or a tracking area update request, preparing a response including a group shared unique identifier. The process also includes sending the response to a user equipment in an attach accept or tracking area update accept message.

In certain embodiments, a non-transitory computer readable medium is encoded with instructions that, when executed in hardware, perform a process. The process includes, upon receiving a paging, waiting a time interval. The process also includes, after waiting the time interval, submitting a service request based on information in a previously received attach accept or tracking area update accept, wherein the information includes a group shared unique identifier.

A non-transitory computer readable medium, in certain embodiments, is encoded with instructions that, when executed in hardware, perform a process. The process includes, upon receiving a group paging, sending a service request to a master user equipment. The master user equipment is configured to send a group service request to a mobility management entity on behalf of user equipments associated with the master user equipment.

A non-transitory computer readable medium is encoded with instructions that, when executed in hardware, perform a process, in certain embodiments. The process includes, upon receiving a group paging, sending a group service request to a mobility management entity. The group paging is received from a mobility management entity. The service request is received from all user equipments associated with a master equipment that performs the sending of the group service request.

### BRIEF DESCRIPTION OF THE DRAWINGS

For proper understanding of the invention, reference should be made to the accompanying drawings, wherein:

FIG. 1 illustrates an evolved packet core architecture.

FIG. 2A illustrates an attach request according to certain embodiments.

FIG. 2B illustrates a tracking area update request according to certain embodiments.

FIG. 3 illustrates a call flow for paging using a shared temporary mobile subscriber identity.

FIG. 4 illustrates an embodiment in which a master user equipment is employed.

FIG. 5 illustrates a method according to certain embodiments.

FIG. 6 illustrates another method according to certain embodiments.

FIG. 7 illustrates a system according to certain embodiments.

### DETAILED DESCRIPTION

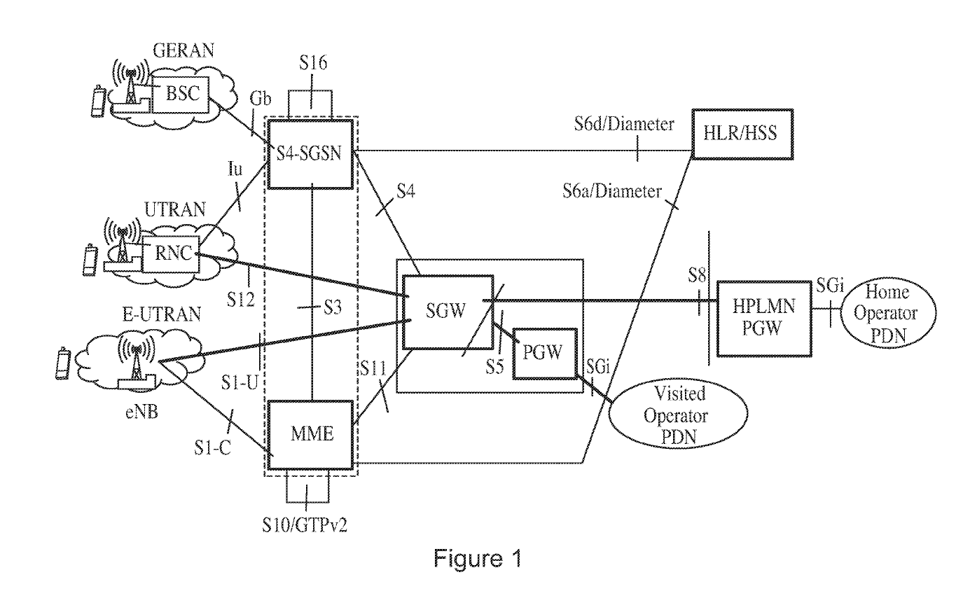

Evolved packet system (EPS) provides new (relative to general packet radio system (GPRS)) radio interface and packet core network functions and devices for broadband wireless data access. Such EPS core network functions and devices are the mobility management entity (MME), packet data network (PDN) gateway (PDN-GW), and serving gateway (S-GW). FIG. 1 illustrates an evolved packet core architecture.

As can be seen in FIG. 1, there may be various interfaces amongst the devices or functionalities, such as the S11 interface between mobility management entity and the serving gateway, or the S5 interface between the serving gateway and the proxy gateway (PGW). There can also be connections to a global system for mobile communication (GSM) edge radio access network (GERAN) base station controller (BSC), serving GPRS support node (SGSN), universal mobile telecommunications system (UMTS) terrestrial radio access network (UTRAN) radio network controller (RNC), or evolved UTRAN (e-UTRAN) eNode B (eNB). Other interfaces may also exist to a home location register (HLR)/home subscriber server (HSS) or a home public land mobile network (HPLMN).

Thus, a common packet domain core network (CN) can be used for both Radio Access Networks (RAN), the GERAN, and the UTRAN (and e-UTRAN). This common core network can provide GPRS services. In order to use packet based services in the operator's domain or Internet the user equipment (UE) can establish a packet bearer towards the proxy gateway/gateway GPRS support node (GGSN).

Certain embodiments provide a shared identifier and an optimized paging procedure using the shared identifier, as well as specifying how the user equipment can react if it is paged in a group. Thus, certain embodiments can apply both to an EPS and a GPRS/UMTS network. The user equipment in FIG. 1 is illustrated as a mobile phone, but any type of terminal device, including a machine type communication device, such as a smart meter, can be included under the category of user equipment.

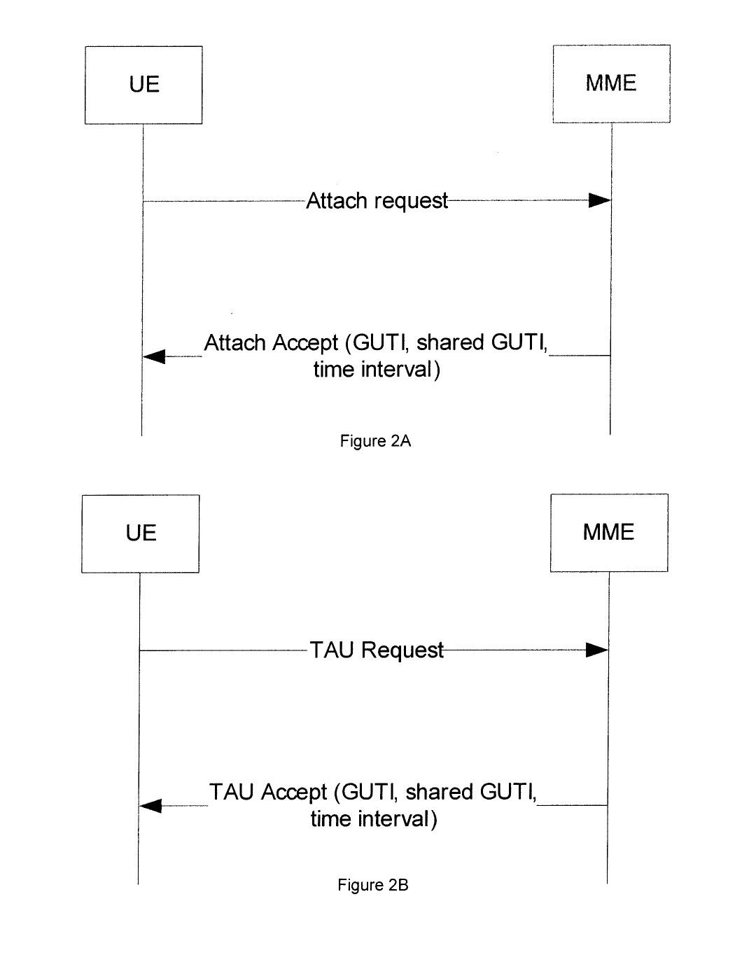

FIG. 2A illustrates an attach request according to certain embodiments. FIG. 2B illustrates a tracking area update (TAU) request according to certain embodiments. As can be seen from FIGS. 2A and 2B, during a machine type communication (MTC) Device Attach/TAU procedure, the mobility management entity (MME) can assign an individual globally unique temporary identity (GUTI) and a group-shared GUTI, for example, system architecture evolution (SAE) temporary mobile subscriber identity (S-TMSI), to a user equipment that supports S1 mode. An S1 mode may be distinguished from an Iu or A/Gb mode, in terms of the use of the S1 interface.

All the machine type communication devices within one special group, such as those which are located within a certain area, can have the same shared globally unique temporary identity, namely a shared temporary mobile subscriber identity. This area may be the whole area served by a mobility management entity, but it could also be a tracking area or group of tracking areas. If a machine type communication device is leaving this area, for example when it is leaving the mobility management entity area, the device's related group shared globally unique temporary identity can also be updated by the mobility management entity in the tracking area update procedure.

The shared S-TMSI can be derived from a shared globally unique temporary identity. The shared globally unique temporary identity can be constructed as follows, under the assumption that it follows the globally unique temporary identity format.

<Group-GUTI>=<MCC>+<MNC>+<MMEGI>+<MMEC>+<unique identifier within the MME>

<Group-S-TMSI>=<MMEC>+<unique identifier within the MME>

MCC can refer to the mobile country code, MNC can refer to the mobile network code, MMEGI can refer to the mobility management entity group identifier, and MMEC can refer to a mobility management entity code.

The shared identifier does not need to be re-allocated while the MTC device remains in the certain area (indeed re-allocation can be avoided), since acknowledgement may not be received from certain user equipment and both the user equipment and network may not be certain whether the currently held identifier is old or new. However, the shared identifier can be reallocated when the machine type communication device moves from one certain area to another one and performs a tracking area update procedure.

The mobility management entity can use a shared S-TMSI to page all the machine type communication devices in one group within the certain area. The mobility management entity can assign a different shared group globally unique temporary identity/S-TMSI to each different machine type communication group.

Together with the identifier, the mobility management entity may send also a time interval. Later, when the machine type communication device receives a paging with the shared identifier, the device responds to the network after expiry of a timer whose value is chosen randomly from this interval. For example, the interval could be 30 seconds. Then, the device would respond randomly at some time between 0 seconds and 30 seconds. The size of the interval may be selected based on the number of devices in the group.

The shared identifier can also be used to determine the paging occasions for the machine type communication group. The paging occasions can be the radio frame and subframe that the machine type communication device needs to monitor for group pagings.

According to 3GPP TS 36.304, subclause 7.1: “PF and PO is determined by following formulae using the DRX parameters provided in System Information: PF is given by following equation: SFN mod T=(T div N)*(UE_ID mod N)[.] Index i_s pointing to PO from subframe pattern defined in 7.2 will be derived from following calculation: i_s=floor(UE_ID/N) mod Ns[.]”

And the parameters are defined, in the same document, as follows: “The following Parameters are used for the calculation of the PF and i_s: T: DRX cycle of the UE. T is determined by the shortest of the UE specific DRX value, if allocated by upper layers, and a default DRX value broadcast in system information. If UE specific DRX is not configured by upper layers, the default value is applied[;]nB: 4 T, 2 T, T, T/2, T/4, T/8, T/16, T/32[;]N: min(T,nB)[;] Ns: max(1,nB/T)[; and] UE_ID: IMSI mod 1024. IMSI is given as sequence of digits of type Integer (0..9), IMSI shall in the formulae above be interpreted as a decimal integer number, where the first digit given in the sequence represents the highest order digit.”

As international mobile subscriber identity (IMSI) is an identifier assigned to an individual machine type communication device, for group paging the UE_ID (“IMSI mod 1024”) can be replaced by a Grouppaging ID, an integer value from the interval [0 . . . 1023] which can be derived by the user equipment and the mobility management entity from the shared identifier. For example, for a shared identifier of the format <Group-GUTI>=<MCC>+<MNC>+<MMEGI>+<MMEC>+<unique identifier within the MME>, the Grouppaging ID could be defined as the 10 least significant bits of the parameter <unique identifier within the MME>.

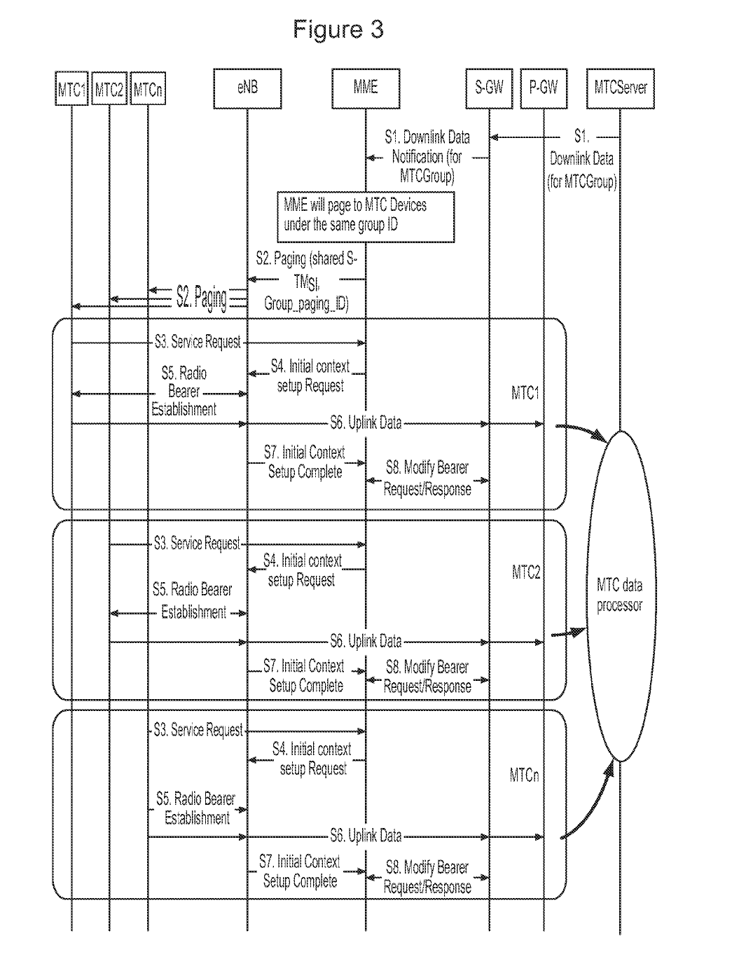

FIG. 3 illustrates a call flow for paging using a shared temporary mobile subscriber identity. As shown in FIG. 3, at S1, a machine type communication (MTC) server has downlink data targeted towards a certain group of devices. These could be devices miming the same application, for example. The machine type communications server notifies the serving gateway (S-GW) with the corresponding group identifier (ID).

Then, at S2, the serving gateway receives the downlink data notification from the MTC Server and forwards the downlink data notification to the mobility management entity (MME) to trigger paging. Thus, the mobility management entity initiates paging with the eNode B (eNB). The mobility management entity provides the shared identifier assigned for the devices within the group (for example, S-TMSI). The mobility management entity may also optionally provide a time interval in an Attach Accept message for the user equipment, to run after paging, to avoid simultaneous service request procedures being performed by all the user equipment within the group. Another alternative is for the mobility management entity to provide a random timer in the Attach Accept message for the user equipment to run after paging. Another alternative is for the mobile management entity to provide a random timer or random timer indicator in the paging request message sent to the user equipment. Meanwhile, the eNB receives the paging message with the shared S-TMSI that points to the group of devices. If a shared temporary identifier is used for multiple devices that are being paged, the paging message can include 1 paging record that contains the shared S-TMSI and the originating core network (CN) domain. Ultimately, the user equipment (UE) receives the paging with the shared identifier. It determines that the S-TMSI is equal to the shared identifier allocated by the core network.

If the mobility management entity provided a time interval in the Attach Accept, the user equipment can run a random timer (chosen randomly from the time interval) prior to initiating, at S3, a service request procedure with the network. Thus use of the random timer may help to avoid or minimize congestion, by avoiding or limiting multiple user equipment initiating service request procedures at the same time. If the mobility management entity provided a random timer in the Attach Accept or paging request message, the user equipment can run the random timer prior to initiating, at S3, the service request procedure with the network. This may have the same effect as the use of the random interval described above. Even if no time interval or random timer was provided, the user equipment can choose its own random timer (randomly) from a default time interval prior to performing, at S3, a service request procedure.

At S4, the mobility management entity can provide an initial context setup request. Subsequently, at S5, the user equipment and eNB can engage in radio bearer establishment. Then, at S6, uplink data can be provided. At S7, the eNB can indicate to the mobility management entity that the initial context setup is complete. Subsequently, at S8, the mobility management entity and the serving gateway can engage in a bearer modification request and response.

If the machine type communication device has received the shared globally unique temporary identity from network, it can calculate corresponding paging occasions (PO) by both its user equipment identity (for example, IMSI) and the shared S-TMSI. In this way, the machine type communication device (one kind of user equipment) may still be reachable for individual paging. Additionally, if the shared S-TMSI is assigned, the UE can wake up at a group paging occasion.

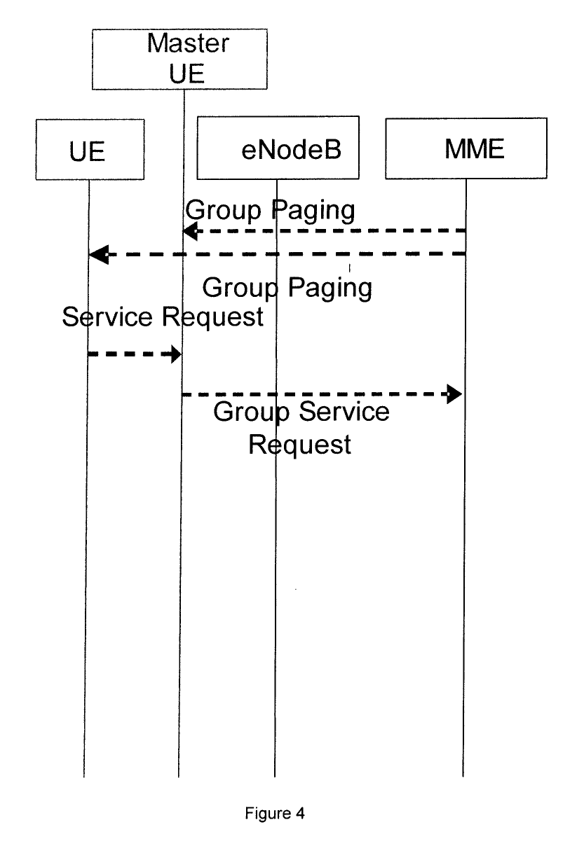

FIG. 4 illustrates an embodiment in which a master user equipment is employed. In this embodiment, a certain user equipment can be assigned as a master user equipment. Then, upon receipt of a group paging, all the other user equipment send the service request to the master user equipment, and the master user equipment signals to the network, as shown in FIG. 4. This can limit the signaling within the network, and shift some of the signaling to an edge network.

A similar procedure, in terms of call flows for group paging and service request, can also apply in the case of a GPRS/UMTS network. In case of a GPRS/UMTS network, a shared packet temporary mobile subscriber identity (P-TMSI) can be used for paging user equipment in a group. It should be noted that although there is reference to “mobile” devices and subscribers, there is no requirement that the user equipment be mobile. Thus, for example, stationary smart meters can be instances of user equipment in certain embodiments.

Certain embodiments may have a variety of effects. For example, certain embodiments reduce simultaneous signaling messages. In certain embodiments, n*2 paging+service request messages can be reduced to just 2 paging and service request messages. The number of signaling messages saved could be significant, when the number n is significantly high.

Embodiments may be used in a variety of practical implementations. For example, in machine type communication services like smart metering, eHealth, people tracking, and fleet management where thousands of devices are deployed, the devices could be grouped based on the applications running in the respective device.

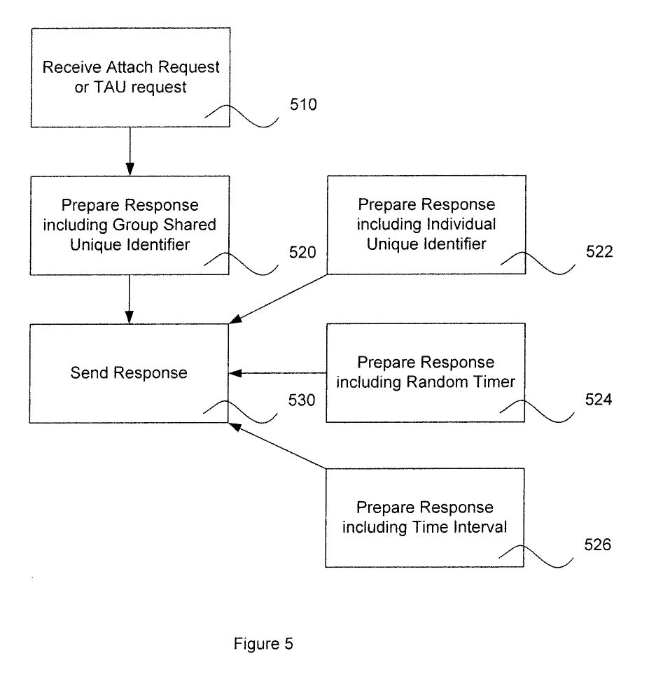

FIG. 5 illustrates a method according to certain embodiments. As shown in FIG. 5, a method can include receiving, at 510, an attach request or a tracking area update (TAU) request. The method can also include preparing, at 520, a response including a group shared unique identifier. The preparing the group shared unique identifier can include preparing a shared temporary mobile subscriber identity, such as a shared S-TMSI. Alternatively, the group shared unique identifier can include a group GUTI, as described above. The preparing the shared temporary mobile subscriber identity can include combining a mobility management entity code and a unique identifier within a mobility management entity.

The preparing the response can involve, at 522, including an individual unique identifier in addition to the group shared unique identifier in the response. The preparing the response can involve, at 524, including a random timer (for example, a specific delay amount in seconds or microseconds) in the response. The preparing the response can involve, at 526, including a time interval in the response (for example, a one-sided or two-sided time interval during which a time can be selected). The method can further include sending, at 530, the response to a user equipment in an attach accept or tracking area update accept message. The group shared unique identifier can be used to determine paging occasions.

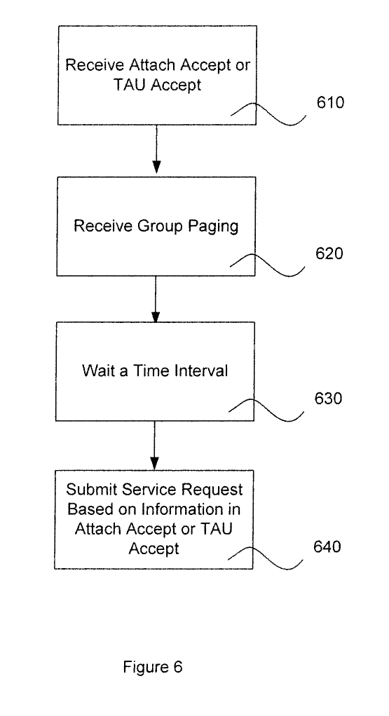

FIG. 6 illustrates another method according to certain embodiments. As shown in FIG. 6, a method can include, at 610, receiving an attach accept or tracking area update (TAU) accept. The method can further include, at 620, receiving a paging, for example, a group paging or a paging including a group shared unique identifier. The method can additionally include, at 630, waiting a time interval. The waiting the time interval can include waiting based on a random timer included in the attach accept or tracking area update accept. The waiting the time interval can include waiting based on a predetermined time interval included in the attach accept or tracking area update accept.

The method can also include, after waiting the time interval, submitting, at 640, a service request based on information in the previously received attach accept or tracking area update accept. The information can include a group shared unique identifier. Then submitting the service request based on the information can involve submitting the service request based on an individual unique identifier.

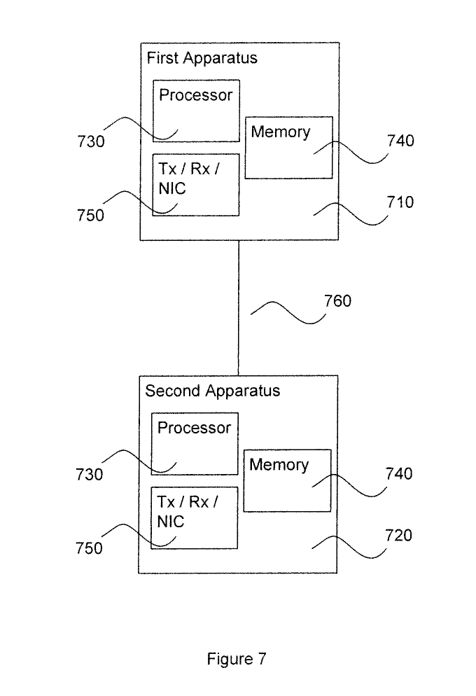

FIG. 7 illustrates a system according to certain embodiments of the present invention. As shown in FIG. 7, the system can include a first apparatus 710 (such as a user equipment) and second apparatus 720 (such as a mobility management entity). Each of the apparatuses may be equipped with at least one processor 730, at least one memory 740 (including computer program instructions), and transceiver/network interface card 750 (other communications equipment, such as an antenna, may also be included). The apparatuses may be configured to communicate with one another over an interface 760, which is shown as a wired interface, but may incorporate both wireless and wired interfaces, as can be seen from, for example, FIG. 1.

The at least one processor 730 can be variously embodied by any computational or data processing device, such as a central processing unit (CPU) or application specific integrated circuit (ASIC). The at least one processor 730 can be implemented as one or a plurality of controllers.

The at least one memory 740 can be any suitable storage device, such as a non-transitory computer-readable medium. For example, a hard disk drive (HDD) or random access memory (RAM) can be used in the at least one memory 740. The at least one memory 740 can be on a same chip as the at least one processor 730, or may be separate from the at least one processor 730.

The computer program instructions may be any suitable form of computer program code. For example, the computer program instructions may be a compiled or interpreted computer program.

The at least one memory 740 and computer program instructions can be configured to, with the at least one processor 730, cause a hardware apparatus (for example, a user equipment, including a master user equipment, or mobility management entity) to perform a process, such as the processes shown in FIGS. 2-6 or any other process described herein.

Thus, in certain embodiments, a non-transitory computer-readable medium can be encoded with computer instructions that, when executed in hardware perform a process, such as one of the processes described above. Alternatively, certain embodiments of the present invention may be performed entirely in hardware.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method, comprising:
preparing a response including a group shared unique identifier, upon receiving an attach request or a tracking area update request; and
sending the response to a user equipment in an attach accept or tracking area update accept message.

2. The method of claim 1, wherein the preparing the group shared unique identifier comprises preparing a shared temporary mobile subscriber identity.

3. The method of claim 2, wherein the preparing the shared temporary mobile subscriber identity comprises combining a mobility management entity code and a unique identifier within a mobility management entity

4. The method of claim 1, wherein the group shared unique identifier is used to determine paging occasions.

5. The method of claim 1, wherein the preparing the response comprises including an individual unique identifier in addition to the group shared unique identifier in the response.

6. The method of claim 1, wherein the preparing the response comprises including a random timer in the response.

7. The method of claim 1, wherein the preparing the response comprises including a time interval in the response.

8. A method, comprising:
waiting a time interval upon receiving a group paging; and
submitting a service request based on information in a previously received attach accept or tracking area update accept after waiting the time interval, wherein the information includes a group shared unique identifier.

9. The method of claim 8, wherein the group shared unique identifier is used to determine paging occasions.

10. The method of claim 8, wherein the submitting the service request based on the information comprises submitting the service request based on an individual unique identifier.

11. The method of claim 8, wherein the waiting the time interval comprises waiting based on a random timer included in the attach accept or tracking area update accept.

12. The method of claim 8, wherein the waiting the time interval comprises waiting based on a predetermined time interval included in the attach accept or tracking area update accept.

13. A method, comprising:
sending a service request to a master user equipment upon receiving a group paging,
wherein the master user equipment is configured to send a group service request to a mobility management entity on behalf of user equipment associated with the master user equipment.

14. A method, comprising:
sending a group service request to a mobility management entity upon receiving a group paging and at least one service request,
wherein the group paging is received from a mobility management entity, and
wherein the service request is received from a user equipment associated with a master equipment that performs the sending of the group service request.

15. An apparatus, comprising:
at least one processor; and
at least one memory including computer program instructions,
wherein the at least one memory and the computer program instructions are configured to, with the at least one processor, cause the apparatus at least to
prepare a response including a group shared unique identifier upon receiving an attach request or a tracking area update request; and
send the response to a user equipment in an attach accept or tracking area update accept message.

16. The apparatus of claim 15, wherein the at least one memory and the computer program instructions are configured to, with the at least one processor, cause the apparatus at least to prepare the group shared unique identifier by preparing a shared temporary mobile subscriber identity.

17. The apparatus of claim 16, wherein the at least one memory and the computer program instructions are configured to, with the at least one processor, cause the apparatus at least to prepare the shared temporary mobile subscriber identity by combining a mobility management entity code and a unique identifier within a mobility management entity.

18. The apparatus of claim 15, wherein the group shared unique identifier is used to determine paging occasions.

19. The apparatus of claim 15, wherein the at least one memory and the computer program instructions are configured to, with the at least one processor, cause the apparatus at least to include an individual unique identifier in addition to the group shared unique identifier in the response.

20. The apparatus of claim 15, wherein the at least one memory and the computer program instructions are configured to, with the at least one processor, cause the apparatus at least to include a random timer in the response.

21. The apparatus of claim 15, wherein the at least one memory and the computer program instructions are configured to, with the at least one processor, cause the apparatus at least to include a time interval in the response.

22. An apparatus, comprising:
at least one processor; and
at least one memory including computer program instructions,
wherein the at least one memory and the computer program instructions are configured to, with the at least one processor, cause the apparatus at least to wait a time interval upon receiving a group paging; and
submit a service request based on information in a previously received attach accept or tracking area update accept after waiting the time interval, wherein the information includes the group shared unique identifier.

23. The apparatus of claim 22, wherein the group shared unique identifier is used to determine paging occasions.

24. The apparatus of claim 22, wherein the at least one memory and the computer program instructions are configured to, with the at least one processor, cause the apparatus at least to submit the service request based on an individual unique identifier.

25. The apparatus of claim 22, wherein the at least one memory and the computer program instructions are configured to, with the at least one processor, cause the apparatus at least to wait the time interval based on a random timer included in the attach accept or tracking area update accept.

26. The apparatus of claim 22, wherein the at least one memory and the computer program instructions are configured to, with the at least one processor, cause the apparatus at least to wait the time interval based on a predetermined time interval included in the attach accept or tracking area update accept.

27. An apparatus, comprising:
at least one processor; and
at least one memory including computer program instructions,
wherein the at least one memory and the computer program instructions are configured to, with the at least one processor, cause the apparatus at least to
send a service request to a master user equipment upon receiving a group paging,
wherein the master user equipment is configured to send a group service request to a mobility management entity on behalf of user equipment associated with the master user equipment.

28. An apparatus, comprising:
at least one processor; and
at least one memory including computer program instructions,
wherein the at least one memory and the computer program instructions are configured to, with the at least one processor, cause the apparatus at least to
send a group service request to a mobility management entity upon receiving a group paging and at least one service request,
wherein the group paging is received from a mobility management entity, and
wherein the service request is received from a user equipment associated with a master equipment that performs the sending of the group service request.

29.-42. (canceled)

43. A non-transitory computer readable medium encoded with instructions that, when executed in hardware, perform a process, the process comprising the method according to claim 1.
